(19) United States
(12) Patent Application Publication
(10) Pub. No.: US 2026/0217385 A1
(43) Pub. Date: Jul. 30, 2026

(54) BEACON SYSTEM FOR AERODROME WITH AIRSHIP

(71) Applicant: Flying Whales, Suresnes (FR)

(72) Inventor: Jacques Calvayrac, Bordeaux (FR)

(21) Appl. No.: 19/149,744

(22) PCT Filed: Jan. 19, 2024
(86) PCT No.: PCT/EP2024/051321

§ 371 Date: Aug. 12, 2025

(30) Foreign Application Priority Data
Jan. 23, 2023 (FR) FR2300611

(51) Int. Cl. B64F 1/14; B64F 1/20

(52) U.S. Cl. CPC B64F 1/14; B64F 1/20

(57) ABSTRACT

A platform for receiving an airship includes a mooring mast, with a light, and a light beacon arrangement of circular configuration defining a secured zone centered on the mooring mast and including: a first zone, referred to as a take-off zone, of circular configuration, delimited by a plurality of guide lights, arranged on a circle centered on the mooring mast, and of predetermined radius; a second zone, referred to as a safety zone, of annular configuration, centered on the mooring mast, delimited by the plurality of guide lights and a plurality of perimeter lights arranged on a circle centered on the mooring mast, the ring having a predetermined radial distance.

### CROSS-REFERENCE TO RELATED APPLICATIONS

This application is a national phase entry under 35 U.S.C. § 371 of International Patent Application PCT/EP2024/051321, filed Jan. 19, 2024, designating the United States of America and published as International Patent Publication WO 2024/156625 A1 on Aug. 2, 2024, which claims the benefit under Article 8 of the Patent Cooperation Treaty of French Patent Application Serial No. FR2300611, filed Jan. 23, 2023.

### TECHNICAL FIELD

The present disclosure relates to a beacon arrangement specifically for airships on platforms dedicated to same. This beacon arrangement is used for night flights in order to guide the crew on board the airship safely to the landing and take-off zone thereof.

### BACKGROUND

To date, there are no beacon arrangements specifically for the use of airships at night. At night, optical and sensory illusions are increased.

Only procedures and ground crew are used to guide the airship.

One aim of the present disclosure is to provide a beacon arrangement for night take-off and landing that ensures air safety.

Another aim of the present disclosure is to provide adaptive guidance of the airship in order to optimize its approach and ensure greater success thereof. This makes it possible to decrease the exposure time of this phase, which is always difficult, once again improving the overall safety of the operation.

### BRIEF SUMMARY

According to a first aspect, the present disclosure provides a platform for receiving an airship, comprising a mooring mast with a light and a light beacon arrangement of circular configuration, called the secured zone, centered on the mooring mast and comprising:
a first zone, called the take-off zone, of circular configuration, delimited by a plurality of lights, called guide lights, arranged on a circle centered on the mooring mast, and of predetermined radius, and
a second zone, called the safety zone, of annular configuration, centered on the mooring mast, delimited by the plurality of lights and a plurality of lights, called perimeter lights, arranged on a second circle centered on the mooring mast, the second circle having a predetermined radial distance.

Advantageously, the plurality of guide lights are regularly angularly spaced around the mooring mast, each of the lights being capable of emitting two distinct colors.

According to another aspect, the present disclosure provides a method for guiding an airship, implemented by a platform according to the first aspect of the present disclosure, or one or more of its refinements, comprising a step of controlling the guide lights and the plurality of lights.

The method can advantageously comprise a step of determining and switching on a guide light, called the wind light, based on an item of wind direction data.

In addition, the method can comprise a step of determining and switching on guide lights called gateway guide lights.

Again advantageously, the gateway lights are determined on the basis of an item of wind strength data.

### BRIEF DESCRIPTION OF THE DRAWINGS

Other advantages and particularities of the present disclosure will become apparent on reading the detailed description of implementations and embodiments that are in no way limiting, with reference to the accompanying drawings, in which:

FIG. 1 illustrates the general arrangement of one example of a platform according to the present disclosure;

FIG. 2 shows one particular light arrangement for the platform illustrated in FIG. 1; and

FIG. 3 schematically shows a Y-shaped guide implemented on the platform illustrated in FIG. 1.

### DETAILED DESCRIPTION

Since the embodiments described below are in no way limiting, it will, in particular, be possible to consider variants of the invention comprising only a selection of the features described, subsequently isolated from the other features described, if this selection of features is sufficient to confer a technical advantage or to differentiate the invention from the prior art. This selection comprises at least one feature, preferably functional, without structural details, or with only a portion of the structural details if this part only is sufficient to confer a technical advantage or to differentiate the invention from the prior art.

In the figures, any element that appears in multiple figures retains the same reference. A platform 1 and a guidance method implemented by the platform are described together.

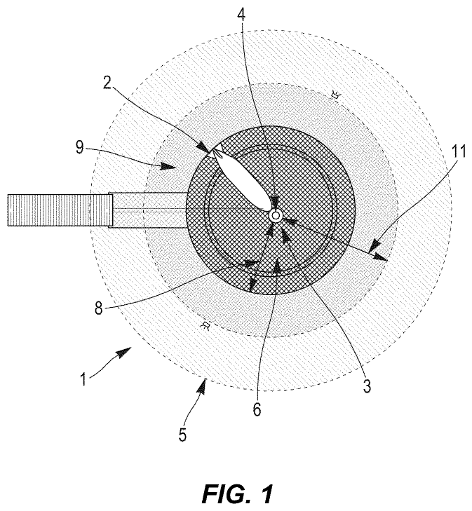

FIG. 1 illustrates the general arrangement of a platform 1 for receiving an airship 2.

The platform 1 comprises a mooring mast 3 with a light 4 and a light beacon arrangement 5 suitable for guiding the airship of circular conformation, called the secured zone, centered on the mooring mast.

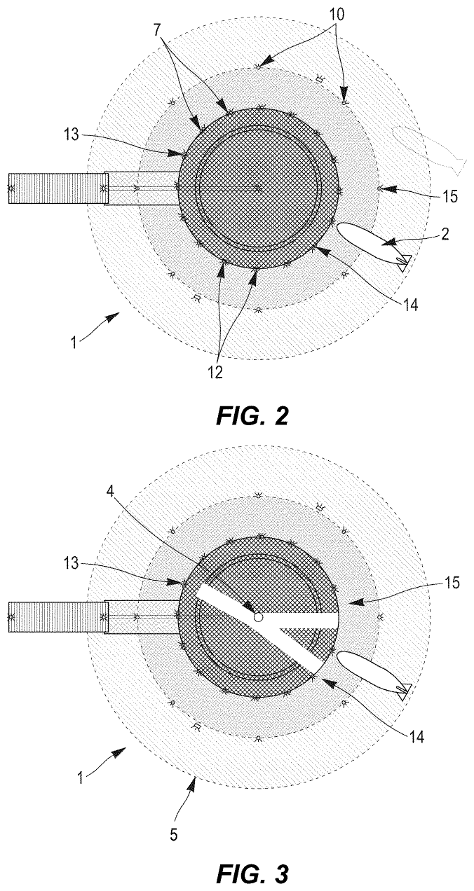

The light beacon arrangement 5 comprises:
a first zone 6, called the take-off zone, also referred to by the term ATOL (area for take-off and landing), of circular configuration, delimited by a plurality of lights 7 (FIG. 2), called guide lights, arranged on a circle centered on the mooring mast 3, and of predetermined radius 8.
a second zone 9, called the safety zone, also referred to by the term clearway, of annular configuration, centered on the mooring mast, delimited by the plurality of lights and a plurality of lights 10 (FIG. 2), called perimeter lights, arranged on a second circle centered on the mooring mast, the second circle having a predetermined radial distance 11.

The particularity of an airship is the need to take off and land while always facing into the wind, which is afforded by the circular area of the proposed arrangement. The take-off area is the zone intended to receive the airship after landing or prior to take-off. The safety zone is an unobstructed zone around the take-off area, to provide additional margins.

The proposed beacon arrangement therefore makes it possible to identify both the take-off zone and the safety zone. The guidance method comprises a step of controlling the guide lights and the plurality of lights.

In one exemplary embodiment, the predetermined radius of the take-off zone is 200 m. In one exemplary embodiment, the predetermined radial distance of the safety zone is 100 m.

The light 4 of the mooring mast 3 makes it possible to detect any drift of the airship 2 relative to the mooring mast, so that it can be corrected as quickly as possible to remain within the secured perimeter.

The perimeter lights 10 are advantageously fixed white omnidirectional lights for delimiting the secured zone. The choice of perimeter lights also ensures that this zone is not mistaken for a conventional airport (for airplanes) or heliport (for helicopters). In the example shown in FIG. 2, the omnidirectional lights are spaced 45° apart around the mooring mast.

Yet another plurality of lights 12, called take-off zone delimitation lights, can be placed on the same circle as the guide lights 7. More specifically, each of the take-off zone delimitation lights 12 can be arranged beside a guide light 7.

The take-off zone delimitation lights 12 must be positioned so that they can be seen by the airship when it is on approach, and not just at a few hundred meters from the zone, thereby allowing it to anticipate the trajectory. For this reason, the delimitation lights are positioned at a predetermined height, for example, between one and two meters.

The guide lights 7 are regularly angularly spaced apart, preferably by 22.5° as illustrated, around the mooring mast and have two distinct emission colors, for example, green and red.

The guidance method can comprise a step of determining and switching on a guide light 13, called the wind light, of a predetermined color, for example, green, based on an item of wind direction data. This light 13 allows wind to be visually indicated, which is mainly from the west in the example shown.

Two other guide lights, 14 and 15, respectively, called gateway lights, arranged on the other side of the mast 3 from the wind light 13, provide lateral guidance for the airship, allowing it to align itself against the wind while anticipating the trajectory to arrive at the center of the take-off zone. The guidance method can comprise a step of determining and switching on gateway lights, preferably of the same predetermined color as the wind light.

FIG. 3 allows the letter Y formed by the wind light 13 and gateway lights 14, 15 to be shown concretely (only for the diagram and for the understanding of the invention). The light 4 at the center of take-off zone is the light of the mast 3. The idea is to create a “Y” shape in order to provide the airship with a gateway that it should enter (the top of the “Y”). In addition, the reference for maintaining the airship-mast axis with a light opposite the entrance gateway (stem of the “Y”) provides a reference for avoiding sideways translations, which are difficult to discern at night.

Advantageously, communication means are provided between the airship and the platform, which are configured to control means for controlling the platform according to the present disclosure.

The means for controlling the platform are configured to control the switching on and off of the various lights of the platform.

Automating control would allow the crew to activate it directly as they arrive in the zone.

Activation of the lights according to wind direction, and, in particular, smart management when the wind is very light or variable (frequent changes in wind direction), will allow the best information to be provided. The option of being able to widen the top of the “Y” will make it possible to indicate whether the wind is substantially constant for a given direction, or whether it is still somewhat variable. This, combined with radio instructions from the ground crew, ensures the safest and most optimized approach for the airship.

Of course, the present disclosure is not limited to the examples that have just been described and numerous modifications can be made to these examples without departing from the scope of the invention. In addition, the different features, forms, variants and embodiments of the present disclosure may be associated with one another in various combinations insofar as they are not incompatible or exclusive of one another.

1. A platform for receiving an airship, comprising:
a mooring mast with a light source; and
a light beacon arrangement of circular configuration defining a secured zone centered on the mooring mast, the secured zone comprising:
a. a first take-off zone of circular configuration delimited by a first plurality of guide lights, arranged on a first circle centered on the mooring mast, the first circle having a predetermined radius; and
b. a second safety zone of annular configuration centered on the mooring mast and delimited by the guide lights and a second plurality of perimeter lights arranged on a second circle centered on the mooring mast, the second circle having a predetermined radial distance from the mooring mast.

2. The platform of claim 1, wherein the guide lights are regularly angularly spaced around the mooring mast, each of the guide lights being capable of emitting two distinct colors.

3. A method for guiding an airship, comprising:
providing a platform for receiving the airship, the platform including:
a mooring mast with a light source; and
a light beacon arrangement of circular configuration defining a secured zone centered on the mooring mast, the secured zone having:
a. a first take-off zone of circular configuration delimited by a first plurality of guide lights arranged on a first circle centered on the mooring mast, the first circle having a predetermined radius; and
b. a second safety zone of annular configuration centered on the mooring mast and delimited by the guide lights and a second plurality of perimeter lights arranged on a second circle centered on the mooring mast, the second circle having a predetermined radial distance from the mooring mast; and
controlling the guide lights and the perimeter lights to guide the airship.

4. The method of claim 3, wherein the guide lights are regularly angularly spaced around the mooring mast, each of the guide lights being capable of emitting two distinct colors, the method further comprising switching on at least one guide light based on wind direction data and using the guide light to guide the airship toward the mooring mast along a direction relative to the wind.

5. The method of claim 4, further comprising switching on two additional guide lights, and using the at least one guide light and the two additional guide lights to guide the airship toward the mooring mast along a direction relative to the wind.

6. The method of claim 5, wherein the two additional guide lights are selected from among the plurality of guide lights using wind strength data.
